(19) United States
(12) Patent Application Publication
(10) Pub. No.: US 2026/0358246 A1
(43) Pub. Date: Nov. 12, 2026

(54) FLUID ANALYZER WITH VAPOR SELF-CHECK

(71) Applicant: Daylight Solutions, Inc., San Diego, CA (US)

(72) Inventors: Gregory Pullen, San Diego, CA (US); H. Ted Stinson, San Diego, CA (US); Rudolph Matthew Bermudez, San Diego, CA (US)

(73) Assignee: Daylight Solutions, Inc., San Diego, CA (US)

(21) Appl. No.: 19/670,998

(22) Filed: May 7, 2026

Related U.S. Application Data
(60) Provisional application No. 63/802,301, filed on May 8, 2025.

(51) Int. Cl. G01N 21/39; G01N 21/31; G01N 21/84; G01N 21/88

(52) U.S. Cl. CPC G01N 21/39; G01N 21/84; G01N 21/8851; G01N 2021/3196; G01N 2021/8416

(57) ABSTRACT

A fluid analyzer for analyzing a liquid sample includes an analyzer housing defining a controlled environment. A test cell is disposed within the analyzer housing and configured to receive the liquid sample. A laser assembly generates an illumination beam directed toward the test cell and a reference beam directed toward a reference detector. A control system varies a wavelength of the illumination beam and the reference beam within a specified time period. Reference data generated by the reference detector is analyzed to perform a self-check that evaluates the presence of unwanted vapor within the analyzer housing. Based on this evaluation, a status of the controlled environment is ascertained to determine suitability for performing spectral analysis of the liquid sample. A purge assembly may be controlled to remove detected vapor.

### CROSS-REFERENCES TO RELATED APPLICATIONS

This application claims priority to U.S. Provisional Patent Application No. 63/802,301, filed on May 8, 2025, which is incorporated by reference for all purposes.

### BACKGROUND

Fluid analyzers are useful for spectrally analyzing a liquid sample to characterize the components of the sample. Many different liquid or dissolved chemicals have strong, identifying optical absorption features in the infrared range of wavelengths. As a result, the fluid analyzer may include a laser assembly that directs an infrared illumination beam at the sample to spectrally analyze the sample.

Unfortunately, solvent vapors, such as water vapor, in the light path of the illumination beam may adversely influence the accuracy of the spectral analysis of the sample.

### BRIEF SUMMARY

The present disclosure is directed to a fluid analyzer that analyzes a sample and performs a self-check. In one implementation, the fluid analyzer includes: (i) a test cell that receives the sample; (ii) a laser assembly that generates an illumination beam that is directed along an illumination light path at the test cell; (iii) a signal detector that receives a signal beam from the test cell, the signal detector being adapted to generate first signal data; (iv) a reference detector that receives a reference beam from the laser assembly, the reference detector being adapted to generate first reference data; (v) an analyzer housing that encircles the test cell; and (vi) a control and analysis system that analyzes the first reference data to perform a first self-check that evaluates the presence of an unwanted vapor in the analyzer housing. With the present design, the one or more self-checks performed by the fluid analyzer reduce the reliance on end users to determine the status of the controlled environment in the analyzer housing, and standardizes the determination of the status of the controlled environment and the fluid analyzer.

Moreover, the self-checks may also be continuously performed, even during the spectral analysis of the sample, to constantly monitor the status of the fluid analyzer. Further, the self-checks may be performed using the existing components in the fluid analyzer.

Additionally, the fluid analyzer may include a purge assembly that directs a purge fluid (e.g., Nitrogen or Argon gas) into the analyzer housing to purge the unwanted vapor from the analyzer housing.

The analyzer housing may be designed to encircle the illumination light path, the signal light path, and the reference light path. For example, the analyzer housing may encircle the laser assembly, the signal detector, and the reference detector.

During a first time period, the wavelength of the illumination beam (e.g., as measured from a central peak of the laser's narrow but finite spectral width) may be varied (a “first sweep”), and the reference detector generates first reference data. Further, the control and analysis system may analyze the first reference data to perform a first self-check to estimate the existence of unwanted vapor in the analyzer housing during the first time period. Additionally, during a second time period that is later in time from the first time period, the wavelength of the illumination beam may be varied (a “second sweep”), and the reference detector generates second reference data. Further, the control and analysis system may analyze the second reference data to perform a second self-check to estimate the existence of unwanted vapor in the analyzer housing during the second time period.

Somewhat similarly, during a third and/or other subsequent time period that is later in time from the first and second time periods, the wavelength of the illumination beam is varied; and the reference detector generates third and/or subsequent reference data. In this design, the control and analysis system analyzes the third reference data to perform a third self-check to estimate if unwanted vapor exists in the analyzer housing during the third time period. Stated differently, during a time period, the wavelength of the illumination beam is varied through the possible values of the sweep. Subsequently, the corresponding reference data is collected during a sweep to estimate the existence of unwanted vapor in the analyzer housing.

Additionally, the control and analysis system analyzes and compares the first reference data and the second reference data to estimate if unwanted vapor exists in the analyzer housing, and to evaluate if the fluid analyzer is operating in a stable fashion.

In some implementations, the control and analysis system analyzes the first reference data to identify sharp absorption (i.e., optical absorption) peaks in the first reference data. Optical absorption refers to the absorption of electromagnetic radiation within a range including but not limited to infrared wavelengths. For example, the control and analysis system may utilize a convex hull on the first reference data to identify sharp absorption peaks in the first reference data. In this design, the control and analysis system may analyze an amplitude of the sharp absorption peaks to estimate how much unwanted vapor exists in the analyzer housing.

Moreover, the control and analysis system may analyze the signal data and the reference data to spectrally analyze the sample during one or more of the time periods.

In a non-exclusive implementation, during the first time period, the reference detector generates the first reference data, and time periods thereafter during a predetermined test time, the reference detector generates separate reference data. As non-exclusive examples, a time period may be 0.5, 1, 2, or 5 seconds, and/or the test time may be 5, 10, 15, 20, 25, 30, 40, 50 or 60 minutes. After the reference data has been collected over the predetermined time period, the reference data from two of the time periods may be compared.

In a specific example, the reference data may be collected every second. In this example, the first reference data from the first time period (t=0 seconds) may be compared to the reference data collected at a time period (t=1800 seconds) which is thirty minutes later to monitor the status of the fluid analyzer. Next, one second later, the reference data collected at t=1801 may be compared to the reference data collected at t=1 second to monitor the status of the fluid analyzer. Subsequently, one second later, the reference data collected at t=1802 may be compared to the reference data collected at t=2 seconds to monitor the status of the fluid analyzer. This process may be repeated over time during the operation of the fluid analyzer to constantly monitor the status.

The wavelength of the illumination beam may be varied through a subset of the possible values of the sweep. For example, the presence of vapor detected in a first sweep may be monitored via one or several discreet wavelengths or via a sweep over a wavelength range smaller than the first, vapor-detecting sweep. Subsequent full sweeps may be executed and analyzed. A combination of these probe methods may comprise a detect, monitor, and/or confirm sequence of improved speed and/or efficiency.

In some implementations, a method for analyzing a housing chamber for the existence of unwanted vapor includes: (i) providing a test cell that receives the sample; (ii) generating an illumination beam that is directed along an illumination light path at the test cell with a laser assembly; (iii) collecting a signal beam from the test cell with a signal detector to generate signal data from the received signal beam; (iv) collecting a reference beam from the laser assembly with a reference detector to generate reference data; (v) encircling the test cell with an analyzer housing, and (vi) analyzing the reference data with a control and analysis system to perform a self-check that evaluates the existence of unwanted vapor in the housing chamber.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 is a simplified schematic illustration of an embodiment of a fluid analyzer.

FIG. 2 is a simplified graph that illustrates an embodiment of spectral reference data collected during a spectral sweep.

FIG. 3 is a graph that illustrates the reference data of FIG. 2 after a parabola has been added.

FIG. 4 is a graph that illustrates that a convex hull has been applied around the data of FIG. 3.

FIG. 5 is a simplified graph that illustrates an embodiment of the reference data of FIG. 2, as well as the convex hull that fits around this data after subtraction of the original parabola.

FIG. 6 is a graph that illustrates an embodiment of the absorbance spectrum generated from the reference data of FIG. 2 and the convex hull fit of FIG. 5.

FIG. 7 is a graph that illustrates an embodiment of a Fourier Filtered rolling ratio spectrum with unwanted vapor.

FIG. 8 is a graph that illustrates an embodiment of a Fourier Filtered rolling ratio spectrum without unwanted vapor.

FIG. 9 is a flowchart illustrating an embodiment of a method for analyzing a chamber for unwanted vapor.

FIG. 10 illustrates an example embodiment of a computer system comprising various hardware elements.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

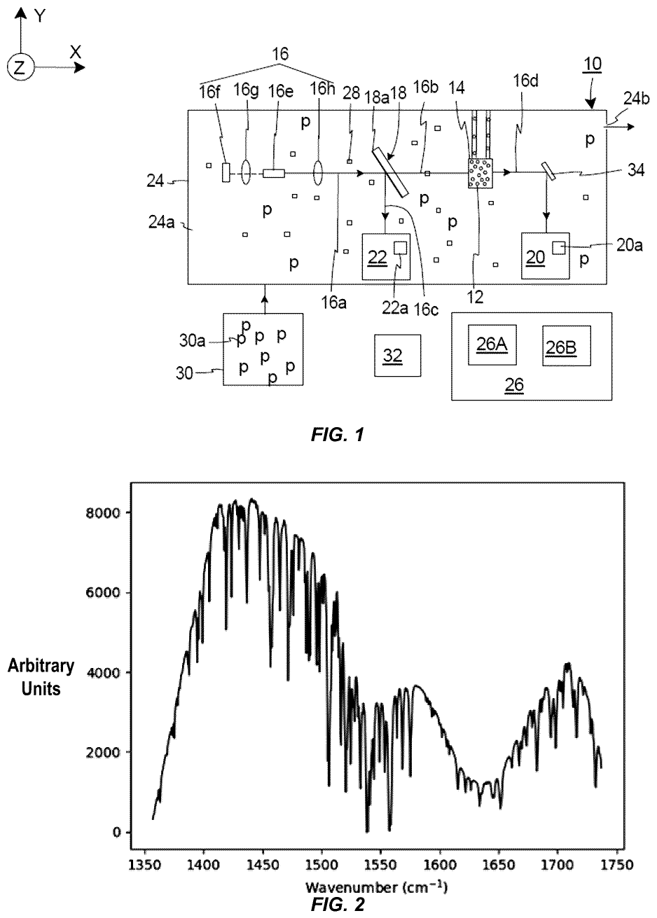

FIG. 1 is simplified illustration of an embodiment of a fluid analyzer 10 for spectrally analyzing a liquid sample 12 (illustrated with small circles). In the non-exclusive implementation of FIG. 1, the fluid analyzer 10 includes (i) a test cell 14 that retains the sample 12, (ii) a laser assembly 16 that generates a laser beam 16a, (iii) a beam splitter 18 that splits the laser beam 16a into an illumination beam 16b that is directed at the sample 12 along an illumination light path and a reference beam 16c, (iv) a signal detector 20 that receives a signal beam 16d from the sample 12, and generates signal data 20a (illustrated as a box), (v) a reference detector 22 that receives the reference beam 16c and generates reference data 22a (illustrated as a box), (vi) an analyzer housing 24; and (vii) a control and analysis system 26 that analyzes the signal data 20a and reference data 22a to evaluate the composition of the sample 12. It should be noted that the number and/or design of components and/or the positioning of the components of the fluid analyzer 10 may be different than that illustrated in FIG. 1. Unwanted vapors include vapors that (i) absorbs infrared radiation in the region being used to interrogate the fluid sample (e.g., acetone that might be used in liquid form to clean an optic or other part within the housing and may persist in vapor form after the enclosure is sealed), or (ii) has sufficient index of refraction at the probe wavelengths such that turbulence or density gradients of the vapor may cause instabilities in the intensities arriving at the signal and/or references detectors due to beam steering effects (e.g., a vapor with a strong absorption near but not precisely at the sample probe wavelength).

In the implementation of FIG. 1, the analyzer housing 24 provides a controlled environment 24a around the sample 12, and the light path of the laser beam 16a, the illumination beam 16b, the reference beam 16c, and the signal beam 16d. The controlled environment 24a will inhibit the absorption and/or scattering of the beams 16a, 16b, 16c, 16d by unwanted vapor 28 (illustrated with small squares), such as water vapor, which may adversely influence the accuracy of the fluid analyzer 10. More specifically, unwanted vapor 28 in the analyzer housing 24 (e.g., specifically in the light path of the laser beam 16a, the illumination beam 16b, the reference beam 16c, and/or the signal beam 16d) may adversely influence the accuracy of the spectral analysis of the sample 12.

Unfortunately, sometimes unwanted vapors 28 may enter into the controlled environment 24a of the analyzer housing 24 (e.g., by seepage, user error, failure to purge, bulk leakage, etc., which may permit unwanted vapor into the controlled environment. In certain implementations, the fluid analyzer 10 may include a purge assembly 30 that selectively directs a purge fluid 30a (illustrated with “p's”) into the analyzer housing 24 to purge the unwanted vapors 28 from the analyzer housing 24.

As an overview, in certain implementations, the fluid analyzer 10 may use the reference data 22a to perform a first type of self-check (referred to as type A self-check) to estimate the levels of unwanted vapors 28 in the analyzer housing 24 at different time periods. Additionally or alternatively, the fluid analyzer 10 may use the reference data 22a to perform a second type of self-check (referred to as type B self-check) to estimate the levels of unwanted vapors and/or the stability of the fluid analyzer 10 over time. It should be noted that either type A self-check, or type B self-check may be referred to as a first, second, third, or subsequent self-check.

In certain implementations, the user of the fluid analyzer 10 may use the information from the self-checks to determine if spectral analysis of the sample 12 should begin or continue. For example, in the event one or both self-check types estimate that the controlled environment 24a is compromised, the user may decide to wait to spectrally analyze the sample 12 until the self-checks estimate that the controlled environment 24a has achieved acceptable levels of unwanted vapors 28 and is stable. Additionally, or alternatively, in the event one of the self-checks estimates that characteristics of the fluid analyzer 10 have changed over time, the user may decide to wait to spectrally analyze the sample 12 until the self-checks estimate that the fluid analyzer 10 has been stabilized. In another implementation, one or more of the self-checks may be used to provide a controlled, repeatable data point for the end user, that will allow the user to decide if they want to proceed or not proceed with spectral analysis.

It should be noted that the self-checks may also be continuously performed, even during the spectral analysis of the sample 12, to constantly monitor the status of the fluid analyzer 10.

In some configurations, self-checks performed by the fluid analyzer 10 reduce the reliance on end users to determine status of the controlled environment 24a and standardizes the determination of status of the controlled environment 24a and the fluid analyzer 10.

Moreover, because the reference data 22a from the reference detector 22 is used to perform the self-checks and to spectrally analyze the sample 12, additional equipment is not necessary. This simplifies the design of the fluid analyzer 10.

Self-checks, in some configurations, are performed without separate reference beam, path, and/or detector. Further, continuous monitoring may be lost or stopped and/or periodic monitoring could remain. Some advantages of some embodiments in include size, weight, power, and/or cost savings.

As illustrated in FIG. 1, a power supply 32 (illustrated as a box) may direct electrical power to the fluid analyzer 10.

The type of sample 12 analyzed with fluid analyzer 10 may be varied. For example, the sample 12 may be a liquid, a complex mixture of multiple liquids, or a complex mixture of liquids, dissolved chemicals, and/or solids. In certain implementations, the sample 12 includes one or more test substances and/or an added solvent. In this implementation, the sample 12 is analyzed by the fluid analyzer 10 to determine the characteristics of the test substance(s).

As non-exclusive examples, the fluid analyzer 10 allows for the simultaneous identification and quantitation (determination of concentration) of many test substances, including large and small molecules, intact or fractionated proteins, functionalized proteins, peptides, amino acids, saccharides, lipids, fats, nucleic acids, DNA and RNA chains, functionalized DNA and RNA chains, fermentation growth media, metabolites, simple sugars (e.g. glucose, maltose, fructose, etc.), formulation buffers, salt buffers, sugar buffers, bodily fluids (e.g. blood serum, urine, sputum) over a wide range of pH conditions.

The type of solvent utilized may be varied. As non-exclusive examples, suitable solvents include water, phosphate-buffered saline (PBS), dimethyl sulfoxide (DMSO), isopropyl alcohol, methyl alcohol, toluene, or tetrahydrofuran (THF).

The test cell 14 retains the liquid sample 12 during spectral analysis with the fluid analyzer 10. For example, the test cell 14 may be a flow cell in which the sample 12 is flowing during the spectral analysis. Alternatively, the test cell 14 may be a receptacle in which the sample 12 is stationary during the spectral analysis. The test cell 14 may be designed to have a relatively short optical path length through the liquid sample 12 being evaluated.

The laser assembly 16 generates the laser beam 16a that is used to evaluate the sample 12. In FIG. 1, the laser assembly 16 is illustrated as a single, tunable, external cavity laser.

Alternatively, the laser assembly 16 may include multiple, individually tunable lasers that span a portion or all of a desired spectral range. For example, when multiple tunable lasers are used, each lasers may generate a different portion of the desired spectral range, with slight overlapping of the wavelength ranges generated to allow for calibration of the laser assemblies and better fidelity. A description of a system that includes multiple individual laser assemblies is described in U.S. Pat. No. 9,086,375, entitled “Laser Source With A Large Spectral Range”. As far as permitted, the contents of U.S. Pat. No. 9,086,375 are incorporated herein by reference.

In the non-exclusive implementation of FIG. 1, the laser assembly 16 is a tunable laser that directly generates and emits the laser beam 16a. In this example, the laser assembly 16 may be an external cavity, Littrow configuration, tunable laser that generates the laser beam 16a that is tunable over a wavelength range, referred to herein as “a tunable range”.

In one specific example, the laser assembly 16 is a tunable mid-infrared (“MIR”) laser, and the tunable range is a portion or all of a mid-infrared range. The term “MIR range” shall mean and include the spectral region between approximately five thousand to five hundred wavenumbers (5000-500 cm−1), or equivalently, between approximately two and twenty microns (2-20 μm) in wavelength. With this design, the laser assembly 16 is tuned to different wavelengths in the MIR range to interrogate the sample 12 at the different wavelengths. The MIR range is particularly useful to spectroscopically interrogate the sample 12 since many samples 12 are comprised of molecules or groups of molecules that have fundamental vibrational modes in the MIR range, and thus present strong, unique absorption signatures within the MIR range.

Alternatively, the laser assembly 16 may be designed to generate the laser beam 16a having the wavelength that is varied outside the mid-infrared range, e.g. another portion of the infrared range or in the visible or ultra-violet range.

In alternative, non-exclusive examples, the size of the tunable (wavelength) range may be at least approximately 2, 3, 4, 5, 8, 10, 15, 18, 20 or 25 micrometers. In additional, alternative, non-exclusive examples, the size of the tunable (wavenumber) range may be at least approximately 50, 100, 200, 300, 400, 500, 1000, 2000, 3000, 4000, 4500, or 5000 cm−1 wavenumbers. However, the size of the tunable range may be larger or smaller than these amounts.

As a non-exclusive example, the laser assembly 16 may include a gain medium 16e (e.g., a quantum cascade gain medium), a wavelength selective feedback element 16f (illustrated as a box)(e.g. a diffraction grating) that may be adjusted to select (tune) the wavelength of the laser beam 16a. As non-exclusive examples, the gain medium 16e may be a Quantum Cascade (QC) gain medium, an Interband Cascade (IC) gain medium, or a mid-infrared diode. Alternatively, another type of gain medium 16e may be utilized.

Additionally, the laser assembly 16 may include an intra-cavity lens 16g that collimates the light in the external cavity, and an output lens 16h that collimates the laser beam 16a that exits the gain medium 16e.

With this design, the control and analysis system 26 may control the input energy (e.g., current) to the gain medium 16e and the wavelength selective feedback element 16f to control the wavelength of the laser beam 16a. Stated in another fashion, the control and analysis system 26 may control the wavelength selective feedback element 16f so that the wavelength of the laser beam 16a is varied over the tunable range. This may be referred to as a spectral sweep. For example, the laser assembly 16 may be tuned, and one or more pulses may be generated having approximately the same first wavelength (“first target wavelength”). Subsequently, the laser assembly 16 may be tuned, and one or more pulses may be generated having approximately the same second wavelength (“second target wavelength”) that is different from the first wavelength. Next, the laser assembly 16 may be tuned, and one or more pulses may be generated having approximately the same third wavelength (“third target wavelength”) that is different from the first and second target wavelengths. This process may be repeated to a plurality of additional target wavelengths throughout a portion or the entire tunable range. As non-exclusive examples, the number of pulses at a discrete target wavelength may be 1, 5, 10, 50, 100, 200, 500, 1000, 10,000 or more. Though using a pulsed laser is described, in some configurations a continuous-wave (CW) laser is used. In some configurations, a “sweep” uses small, but discrete, steps between wavelengths. In some configurations, the steps between wavelengths for a sweep is equal to or less than 0.1, 0.5, or 1 nm. In some embodiments, the steps between wavelengths in a sweep are uniform. For example, each step is 0.1, 1.0 nm, or 10 nm. In some configurations, discrete target wavelengths are separated by larger and/or non-uniform steps. For example, steps are equal to or greater than 1.5, 2, 5, or 10 nm (and/or equal to or less than 50 or 100 nm) and/or steps between three, four, five, or more target wavelengths are not equal.

The number of discrete target wavelengths in the set used to analyze the sample 12 during a spectral sweep may also vary according to the sample 12. As non-exclusive examples, the number of discrete target wavelengths utilized may be approximately 1, 2, 3, 4, 5, 6, 7, 8, 9, 10, 15, 20, 25, 40, 200, 226, 400, 552 or 4000 within the tunable range.

As non-exclusive examples, the control and analysis system 26 may control the laser assembly 16 so that the spectral sweep occurs in less than 1 millisecond, 10 millisecond, 100 millisecond, 1 second, 10 seconds, or 100 seconds.

During the self-checks and/or the spectral analyses of the sample, the control and analysis system 26 may control the laser assembly 16 so that the wavelength of the laser beam 16a is varied over the desired tunable range, for one or more of a plurality of sequential time periods. As a specific example, the control and analysis system 26 may control the laser assembly 16 (i) to perform a first spectral sweep (vary wavelength) during a first period of time over the tunable range; (ii) to perform a second spectral sweep during a second period of time over the tunable range; (iii) to perform a third spectral sweep during a third period of time over the tunable range; (iv) to perform a fourth spectral sweep during a fourth period of time over the tunable range; (v) to perform a fifth spectral sweep during a fifth period of time over the tunable range; and (vi) et cetera. In this example, each time period may be a different period of time.

The beam splitter 18 splits the laser beam 16a into an illumination beam 16b that is directed along an illumination light path at the test cell 14 and the sample 12, and a reference beam 16c that is directed along a reference light path at the reference detector 22. For example, the beam splitter 18 may be made of zinc selenide, Calcium Fluoride, Germanium, Silicon, or other infrared transmissive or partially transmissive optical material. Furthermore, the beam splitter may be coated to achieve a desired split ratio. As non-exclusive examples, the beam splitter 18 may split approximately one, two, three, four, five, ten, twenty, or fifty percent of the laser beam 16a to create the reference beam 16c.

The signal detector 20 receives at least a portion of the signal beam 16d from the test cell 14 and the sample 12, and generates the signal data 20a for each period of time. In FIG. 1, the signal beam 16d follows a signal light path from the test cell 14 to the signal detector 20. In one implementation, the signal detector 20 senses the signal beam 16d and converts the signal beam 16d into a detector count for each wavelength of the illumination beam 16b. In one implementation, the signal detector 20 includes a single, photosensitive element that is sensitive to the wavelength of the laser beam 16a. In some configurations, the signal detector 20 may be a one-dimensional or two-dimensional array of photosensitive elements.

The reference detector 22 receives at least a portion of the reference beam 16c and generates the reference data 22a for each period of time. In one implementation, the reference detector 22 senses the reference beam 16c and converts the reference beam 16c into a detector count for each wavelength of the reference beam 16c. The reference detector 22 may be similar in design to the signal detector 20.

In the non-exclusive implementation of FIG. 1, the fluid analyzer 10 may include a beam director 34 that directs the signal beam 16d from the test cell 14 at the signal detector 20. For example, the beam director 34 may be a mirror or another type of beam director.

The analyzer housing 24 retains one or more of the components of the fluid analyzer 10 and provides the controlled environment 24a around at least a portion of the components of the fluid analyzer 10. For example, the analyzer housing 24 may be box shaped and form the housing cavity that encloses the other components and light paths.

In FIG. 1, the analyzer housing 24 is rigid, supports, and encloses the test cell 14, the laser assembly 16, the beam splitter 18, the signal detector 20, the reference detector 22, and the beam director 34. With this design, the analyzer housing 24 may be used to provide the controlled environment 24a for these components, the sample 12, and the beams 16a, 16b, 16c, 16d. Stated differently, the controlled environment 24a will inhibit the absorption and/or scattering of the beams 16a, 16b, 16c, 16d by unwanted vapor 28. This will improve the accuracy of the spectral data collected by the fluid analyzer 10.

In one implementation, the purge assembly 30 is in fluid communication with the controlled environment 24a so that the purge assembly 30 may selectively direct the purge fluid 30a into the controlled environment 24a. In one implementation, the purge assembly 30 is controlled to continuously direct the purge fluid 30a into the analyzer housing 24 during the operation of the fluid analyzer 10. Alternatively, the purge assembly 30 may be controlled to intermittently direct the purge fluid 30a into the analyzer housing 24 during the operation of the fluid analyzer 10.

Additionally, in one implementation, the analyzer housing 24 may include one or more housing openings 24b that allows for the excess purge fluid 30a and the unwanted vapor 28 to be expelled from the controlled environment 24a.

The design of the purge assembly 30 may be varied depending upon the type of purge fluid 30a. For example, the purge assembly 30 may include one or more pumps, reservoirs, valves and/or other devices.

The type of purge fluid 30a utilized may be varied depending on the desired spectral range of the laser beam 16a. Non-exclusive examples of suitable purge fluids 30a include gases such as dry nitrogen, dry air, helium, argon, or carbon dioxide.

The control and analysis system 26 controls one or more components of the fluid analyzer 10. For example, the control and analysis system 26 may control the operation of the laser assembly 16, the detectors 20, 22, and the purge assembly 30. Moreover, the control and analysis system 26 may analyze the data generated by the detectors 20, 22 to characterize one or more test substances of the sample 12. Further, the control and analysis system 26 may analyze the data generated by the reference detector 22 to estimate the amount of unwanted vapor 28 in the analyzer housing 24, and/or to characterize the stability of the fluid analyzer 10.

In certain embodiments, the control and analysis system 26 may include one or more processors 26A and/or electronic data storage devices 26B. It should be noted that the control and analysis system 26 is illustrated in FIG. 1 as a single, central processing system. Alternatively, the control and analysis system 26 may be a distributed processing system. Additionally, the control and analysis system 26 may include a display (e.g. LED display) that displays relevant information.

As provided herein, the control and analysis system 26 may utilize the reference data 22a to perform one or more type A self-checks to estimate the levels of unwanted vapors 28 in the analyzer housing 24 at different time periods. Additionally or alternatively, the fluid analyzer 10 may use the reference data 22a to perform one or more type B self-checks to estimate the levels of unwanted vapors and/or the stability of the fluid analyzer 10 over time. The type and design of the self-checks performed by the control and analysis system 26 may be varied pursuant to the teachings provided herein.

In one implementation, each type A self-check may be designed to be a rough purge status test that is performed quickly (e.g., less than 1, 2, 5, 10, or 60 seconds) to determine if there is a large concentration of unwanted vapor 28 inside the analyzer housing 24. Further, each type B self-check may be designed to be a fine purge status test that uses collecting data for a relatively long, test time (e.g., five, ten, twenty, thirty, or sixty minutes), and only after that may the control and analysis system 26 determine if the instrument has been sufficiently purged to eliminate unwanted vapor 28 spectral measurement issues. In certain designs, only when both the type A self-check and the type B self-check test indicate the fluid analyzer 10 is purged, then the control and analysis system 26 will notify the user that the fluid analyzer 10 is fully purged of unwanted vapor 28, and ready for spectral analysis of the sample 12.

In one implementation, each type A self-check rapidly evaluates and/or estimates the amount of unwanted vapor 28 in the analyzer housing 24 at a different period of time. More specifically, (i) during the first period of time, the wavelength is varied by the laser assembly 16, and the reference detector 22 collects first reference data that is used to estimate the amount of unwanted vapor 28 at that time; (ii) during the second period of time, the wavelength is varied by the laser assembly 16, and the reference detector 22 collects second reference data that is used to estimate the amount of unwanted vapor 28 at that time; (iii) during the third period of time, the wavelength is varied by the laser assembly 16, and the reference detector 22 collects third reference data that is used to estimate the amount of unwanted vapor 28 at that time; (iv) during the fourth period of time, the wavelength is varied by the laser assembly 16, and the reference detector 22 collects fourth reference data that is used to estimate the amount of unwanted vapor 28 at that time; (v) during the fifth period of time, the wavelength is varied by the laser assembly 16, and the reference detector 22 collects fifth reference data that is used to estimate the amount of unwanted vapor 28 at that time; and (vi) et cetera. The type A self-check may be performed continuously during the operation of the fluid analyzer 10, including before and during spectral analysis of the sample 12.

It should be noted that (i) the first reference data will be influenced by unwanted vapor 28 in the light path from the wavelength selective feedback element 16f to the reference detector 22 during the first period of time; (ii) the second reference data will be influenced by unwanted vapor 28 in the light path from the wavelength selective feedback element 16f to the reference detector 22 during the second period of time; (iii) the third reference data will be influenced by unwanted vapor 28 in the light path from the wavelength selective feedback element 16f to the reference detector 22 during the third period of time; (iv) the fourth reference data will be influenced by unwanted vapor 28 in the light path from the wavelength selective feedback element 16f to the reference detector 22 during the fourth period of time; (v) the fifth reference data will be influenced by unwanted vapor 28 in the light path from the wavelength selective feedback element 16f to the reference detector 22 during the fifth period of time; (vi) et cetera. With reference to FIG. 1, if unwanted vapor 28 is present in the housing chamber 24 and being moved by the purging fluid 30a, (i) during certain time periods, the unwanted vapor 28 may be in the light path from the wavelength selective feedback element 16f to the reference detector 22; and (ii) during other time periods, the unwanted vapor 28 may be out of the light path from the wavelength selective feedback element 16f to the reference detector 22. Thus, multiple type A self-checks may be necessary to accurately estimate when the housing chamber 24 is adequately purged of the unwanted vapor 28.

As non-exclusive examples, 10, 20, 30, 40, 50, 100, 500, 1000 or more type A self-checks may be necessary to achieve ‘purged’ status of the housing chamber 24, purged of the unwanted vapor 28, as determined by the type A self-check.

The type of analysis performed by the control and analysis system 26 on the reference data during each type A self-check may be varied pursuant to the teachings provided herein. In one implementation, the present disclosure teaches that unwanted vapor 28 (gas phase molecules) typically have very sharp and narrow absorption peaks (“absorption spikes”) in the mid-infrared spectral range. This is in contrast to liquids which typically have relatively smooth and broad absorption peaks. With the present design, if unwanted vapor 28 is in the light path from the wavelength selective feedback element 16f to the reference detector 22, the resulting reference data will include sharp and narrow absorption peaks that would not be present in the absence of the unwanted vapor 28.

In one implementation, for each type A self-check, the control and analysis system 26 analyzes the corresponding reference data to identify sharp and narrow absorption peaks. Subsequently, the control and analysis system analyzes the sharp and narrow spikes to estimate how much unwanted vapor exists in the analyzer housing.

The type of algorithm used by the control and analysis system 26 to identify sharp and narrow absorption peaks in the reference data may be varied. For example, the control and analysis system 26 may analyze the reference data to identify and remove smooth and broad absorption data, leaving only the sharp spikes.

FIG. 2 is a graph that illustrates the first reference data (detector counts versus wavenumber) collected during the first period of time. In one implementation, the control and analysis system 26 utilizes a convex hull algorithm to generate a convex hull baseline on the first reference data to identify sharp spikes in the first reference data. The convex hull baseline is used to calculate the maximum absorbance of the current reference data.

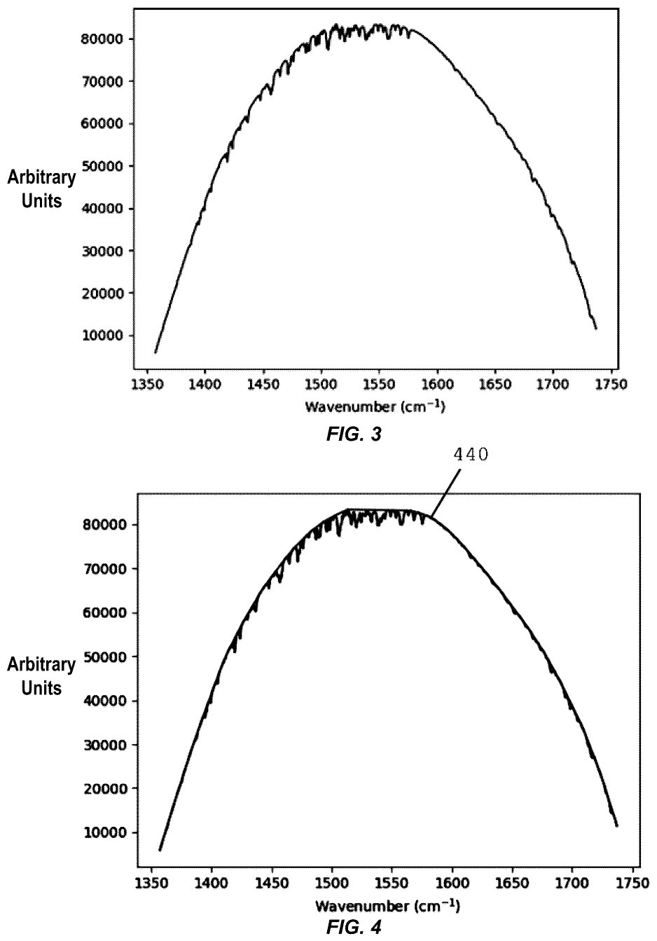

In one implementation, to create the convex hull baseline, the control and analysis system 26 adds a parabola to the reference data of FIG. 2. FIG. 3 is a graph that illustrates the resulting reference data after a parabola has been added by the control and analysis system 26 to remove most of the large and/or broad concavity. By adding the parabola and thus removing the concavity from FIG. 2, the convex hull algorithm suppresses smooth and broad features of the reference data. As a result, only sharp and narrow peaks remain.

FIG. 4 is a graph that illustrates that a convex hull 440 has been calculated to fit around the parabola data of FIG. 3 by the control and analysis system 26.

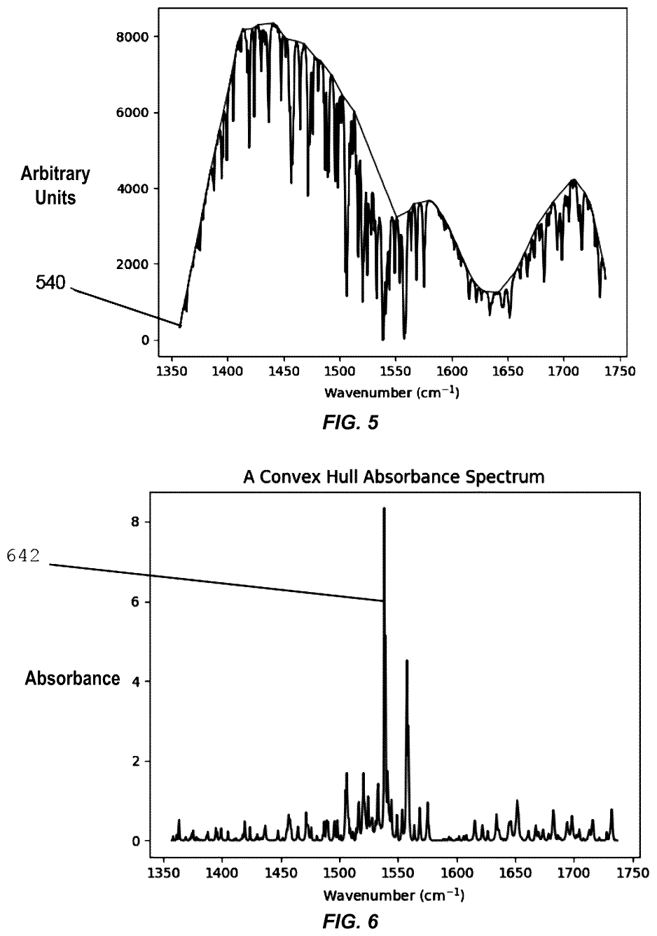

FIG. 5 is a simplified graph that illustrates the original reference data of FIG. 2, along with the convex hull minus parabola 540, as generated by the control and analysis system 26. In order to create the convex hull minus parabola 540, the parabola that was added to generate FIG. 3 is now subtracted from the convex hull 440 of FIG. 4.

Next, an absorbance spectrum of the sharp and narrow peaks is generated from the original reference data of FIG. 2 and the convex hull minus parabola 540. The absorbance spectrum is calculated as the logarithm of the ratio of the convex hull minus parabola 540 divided by the original reference data of FIG. 2.

FIG. 6 is a graph that illustrates the convex hull absorbance spectrum for the reference data of FIG. 2 generated by the control and analysis system 26. Basically, FIG. 6 illustrates the first reference data highlighting the sharp absorption peaks 642, after the smooth and broad absorption features have been removed. In FIG. 6, the sharp absorption peaks 642 correspond to absorption due to unwanted vapor 28 during the first time period.

As provided herein, the control and analysis system 26 may analyze the amplitude of these sharp absorption peaks 642 to determine and quantify the presence of unwanted vapor 28 in the housing chamber 24. For example, if the amplitude of these sharp absorption peaks 642 is above a predetermined threshold, the housing chamber 24 is considered to have unwanted vapor 28, and the fluid analyzer 10 may be considered to have failed the type A self-check for the first time period. Alternatively, if the amplitude of some or all of these sharp absorption peaks 642 is below a predetermined threshold, the housing chamber 24 is considered to not have unwanted vapor 28, and fluid analyzer 10 passed the type A self-check for the first time period.

The value for the predetermined threshold may be varied. As non-exclusive examples, the predetermined threshold may be less than approximately 0.2, 0.5, 0.6, 0.8, 1, or 1.2 absorbance. However other values are possible.

In a specific example, the predetermined threshold is 0.8 absorbance. In FIG. 6, at least one of the sharp absorption peaks 342 has an amplitude greater than 0.8. Thus, the fluid analyzer 10 may be considered to have failed the type A self-check for the first time period.

The type of analysis performed by the control and analysis system 26 on the reference data during each type B self-check may be varied pursuant to the teachings provided herein. In one implementation, the type B self-checks utilize and compare reference data collected over relatively long periods of time (“test times”).

For example, the control and analysis system 26 may utilize the reference data collected over a predetermined time period to analyze the characteristics of the fluid analyzer 10. The length of test time may be varied. For example, the test time may be 5, 10, 15, 20, 25, 30, 40, 50 or 60 minutes. However, other lengths of test times are possible.

In one implementation, the control and analysis system 26 uses the reference data to calculate the standard deviation of a flattened rolling ratio for the predetermined test time. This may be performed by the control and analysis system 26 by (i) generating a ratio between the current reference data and a previous reference data collected at the start of the predetermined time period (e.g., ratio of first reference data (e.g., taken at minute one-start of test time) to a later reference data (e.g., taken after thirty minutes-at the end of the test time); (ii) calculating the fast Fourier transform of this data ratio; (iii) zeroing several (e.g., five) of the lowest frequency terms of the fast Fourier transform; (iv) calculating the inverse fast Fourier transform of the result; (v) calculating the standard deviation of this flattened spectrum; and (vi) comparing the standard deviation to a predetermined threshold to determine if unwanted vapor 28 is present and/or if the system is stable. Steps (i) to (iv) are referred to as Fourier Filtering and this filtering creates the flattened ratio spectrum. The rolling ratio is what results from the time points of the current reference data and the previous reference data both moving forward in time. As a non-exclusive example, if the first rolling ratio spectrum is calculated from minute thirty reference data and minute one reference data, then the second rolling ratio spectrum is calculated from minute thirty-one reference data and minute two reference data; then the third rolling ratio spectrum is calculated from minute thirty-two reference data and minute three reference data. This pattern may continue indefinitely.

If the standard deviation is above a predetermined threshold, water vapor is deemed present as determined by the type B self-check, or the fluid analyzer 10 is deemed not stable enough as determined by the type B self-check. In one, non-exclusive example, the predetermined threshold value is 1.5e-3. However, other values may be utilized.

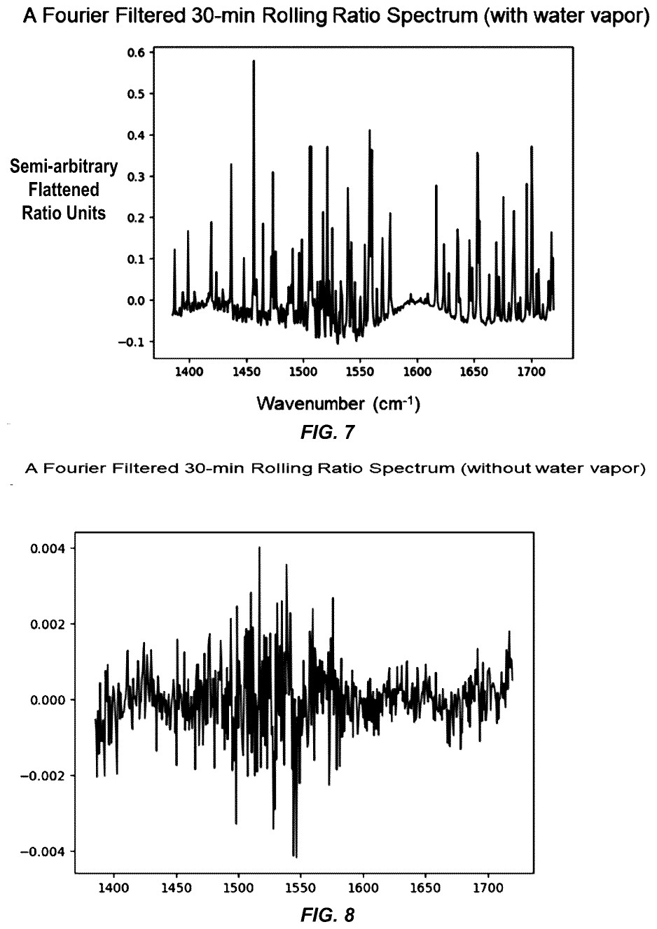

FIG. 7 is a graph that illustrates a Fourier Filtered rolling ratio spectrum taken in the presence of unwanted vapor. In this example, the standard deviation of the Fourier Filtered rolling ratio data is greater than the predetermined threshold value. Therefore, the type B self-check has determined that either water vapor is present or the fluid analyzer 10 is not stable enough.

In contrast, FIG. 8 is a graph that illustrates a Fourier Filtered rolling ratio spectrum without unwanted vapor. In this example, the standard deviation of the Fourier Filtered rolling ratio data is less than the predetermined threshold value. Therefore, the type B self-check has determined that water vapor is not present and the fluid analyzer 10 is stable enough.

With reference to FIG. 1, in certain implementations, the user may utilize the information from the self-checks to determine if spectral analysis of the sample 12 should begin or continue. For example, in the event one or both self-check types estimates that the controlled environment 24a is compromised, the user may decide to wait to spectrally analyze the sample 12 until the self-checks estimate that the controlled environment 24a has achieved acceptable levels of unwanted vapors 28 and is stable. Additionally, or alternatively, in the event one of the self-checks estimate that characteristics of the fluid analyzer 10 have changed over time, the user may decide to wait to spectrally analyze the sample 12 until the self-checks estimate that the fluid analyzer 10 has been stabilized. In another implementation, one or more of the self-checks may be used to provide a controlled, repeatable data point for the end user, that will allow the user to decide if they want to proceed or not proceed with spectral analysis.

In another implementation, multiple type A self-checks indicate “pass” and at least one type B self-check indicate “pass” before spectral analysis of the sample 12 should begin.

It should be noted that the self-checks may also be continuously performed, even during the spectral analysis of the sample 12, to constantly monitor the status of the fluid analyzer 10. This mode of operation may allow trace components of the sample 12 to be identified and quantified with improved accuracy.

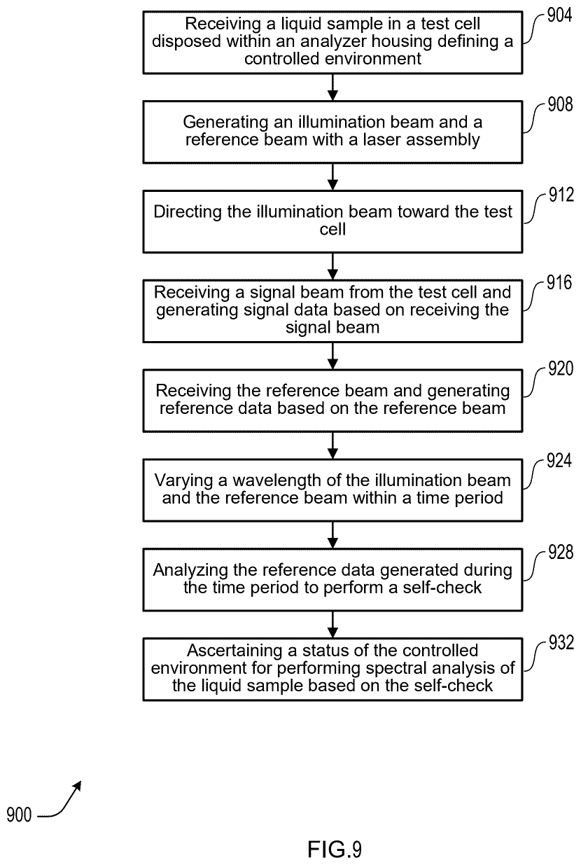

FIG. 9 is a flowchart illustrating an embodiment of a process 900 for analyzing a chamber (e.g., a controlled environment 24a) for unwanted vapor 28. The process 900 may be implemented using the fluid analyzer 10 and the control and analysis system 26.

At step 904, process 900 includes receiving a liquid sample 12 in a test cell 14. The test cell 14 is disposed within an analyzer housing 24 that defines a controlled environment 24a to inhibit interference from external atmospheric conditions.

At step 908, a laser assembly 16 generates an illumination beam 16b and a reference beam 16c. In some embodiments, the laser assembly 16 is a tunable mid-infrared (MIR) laser configured to operate across a spectral range between approximately 2 and 20 microns.

At step 912, the illumination beam 16b is directed toward the test cell 14 along an illumination light path.

At step 916, a signal detector 20 receives a signal beam 16d from the test cell 14 and generates signal data 20a based on the received signal beam 16d.

At step 920, a reference detector 22 receives the reference beam 16c and generates reference data 22a based on the reference beam 16c.

At step 924, the control and analysis system 26 instructs the laser assembly 16 to vary a wavelength of the illumination beam 16b and the reference beam 16c within a time period. This variation may include a spectral sweep across a predetermined tunable range.

At step 928, the control and analysis system 26 analyzes the reference data 22a generated during the time period to perform a self-check. In one implementation, the self-check (e.g., a “Type A” self-check) evaluates the presence of unwanted vapor 28 within the analyzer housing 24 by identifying sharp and narrow absorption peaks in the reference data 22a, potentially utilizing a convex hull algorithm. In another implementation, the self-check (e.g., a “Type B” self-check) comprises a stability check that involves calculating a standard deviation of a flattened rolling ratio of reference data 22a collected over a predetermined test time.

At step 932, the control and analysis system 26 ascertains a status of the controlled environment 24a for performing spectral analysis of the liquid sample 12 based on the self-check evaluating the presence of the unwanted vapor 28. Based on the ascertained status, the system may perform responsive actions such as: (i) controlling a purge assembly 30 to direct a purge fluid 30a into the analyzer housing 24; (ii) initiating spectral analysis of the liquid sample 12 only when the presence of unwanted vapor 28 is below a predetermined threshold; and/or (iii) transmitting an electronic notification to a user interface indicating the readiness or stability of the fluid analyzer 10.

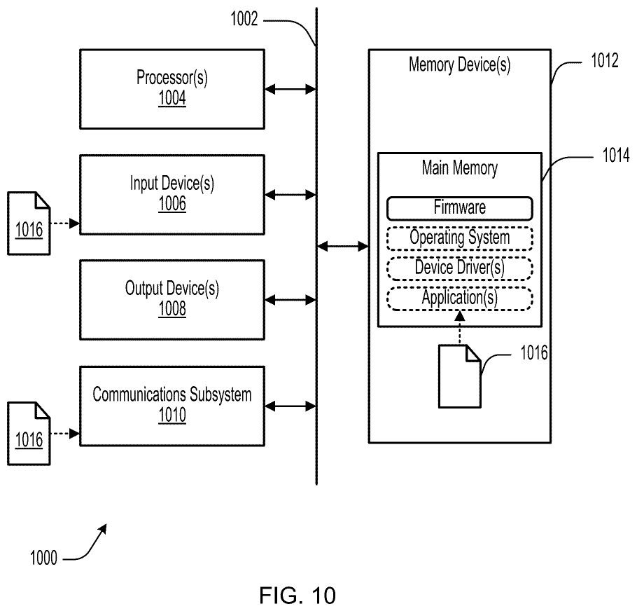

FIG. 10 illustrates an example computer system 1000 comprising various hardware elements, according to some embodiments. Computer system 1000 may be incorporated into or integrated with devices described herein and/or may be configured to perform some or all of the steps of the methods provided by various embodiments. It should be noted that FIG. 10 is meant only to provide a generalized illustration of various components, one or more of which may be utilized as appropriate. FIG. 10, therefore, broadly illustrates how individual system elements may be implemented in a relatively separated or relatively more integrated manner.

In the illustrated example, computer system 1000 includes a communication medium 1002, one or more processor(s) 1004, one or more input device(s) 1006, one or more output device(s) 1008, a communications subsystem 1010, and one or more memory device(s) 1012. Computer system 1000 may be implemented using various hardware implementations and embedded system technologies. For example, one or more elements of computer system 1000 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities.

The various hardware elements of computer system 1000 may be coupled via communication medium 1002. While communication medium 1002 is illustrated as a single connection for purposes of clarity, it should be understood that communication medium 1002 may include various numbers and types of communication media for transferring data between hardware elements. For example, communication medium 1002 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 1002 may include one or more buses connecting pins of the hardware elements of computer system 1000. For example, communication medium 1002 may include a bus connecting processor(s) 1004 with main memory 1014, referred to as a system bus, and a bus connecting main memory 1014 with input device(s) 1006 or output device(s) 1008, referred to as an expansion bus. The system bus may comprise several elements, including an address bus, a data bus, and a control bus. The address bus may carry a memory address from processor(s) 1004 to the address bus circuitry associated with main memory 1014 in order for the data bus to access and carry the data contained at the memory address back to processor(s) 1004. The control bus may carry commands from processor(s) 1004 and return status signals from main memory 1014. A bus may include multiple wires for carrying multiple bits of information, and a bus may support serial or parallel transmission of data.

Processor(s) 1004 may include one or more central processing units (CPUs), graphics processing units (GPUs), neural network processors or accelerators, digital signal processors (DSPs), and/or the like. A CPU may take the form of a microprocessor, which is fabricated on a single IC chip of metal-oxide semiconductor field-effect transistor (MOSFET) construction. Processor(s) 1004 may include one or more multi-core processors, in which one or more cores may read and execute program instructions simultaneously with the other cores.

Input device(s) 1006 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. Input device(s) 1006 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 1008 may include one or more of various devices that convert information into human-readable form, such as without limitation a display device, a speaker, a printer, and/or the like. Output device(s) 1008 may also include devices for writing to removable storage devices or other removable media, such as those described in reference to input device(s) 1006. Output device(s) 1008 may also include various actuators for causing physical movement of one or more components. Such actuators may be hydraulic, pneumatic, and/or electric, and may be provided with control signals by computer system 1000.

Communications subsystem 1010 may include hardware components for connecting computer system 1000 to systems or devices that are located external computer system 1000, such as over a computer network. In various embodiments, communications subsystem 1010 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 1012 may include the various data storage devices of computer system 1000. For example, memory device(s) 1012 may include various types of computer memory with various response times and capacities, from faster response times and lower capacity memory, such as processor registers and caches (e.g., L0, L1, L2), to medium response time and medium capacity memory, such as random access memory, to lower response times and lower capacity memory, such as solid state drives and hard drive disks. While processor(s) 1004 and memory device(s) 1012 are illustrated as being separate elements, it should be understood that processor(s) 1004 may include varying levels of on-processor memory, such as processor registers and caches that may be utilized by a single processor or shared between multiple processors.

Memory device(s) 1012 may include main memory 1014, which may be directly accessible by processor(s) 1004 via the memory bus of communication medium 1002. For example, processor(s) 1004 may continuously read and execute instructions stored in main memory 1014. As such, various software elements may be loaded into main memory 1014 to be read and executed by processor(s) 1004 as illustrated in FIG. 10. Typically, main memory 1014 is volatile memory, which loses data when power is turned off and accordingly uses power to preserve stored data. Main memory 1014 may further include a small portion of non-volatile memory containing software (e.g., firmware, such as BIOS) that is used for reading other software stored in memory device(s) 1012 into main memory 1014. In some embodiments, the volatile memory of main memory 1014 is implemented as random-access memory (RAM), such as dynamic RAM (DRAM), and the non-volatile memory of main memory 1014 is implemented as read-only memory (ROM), such as flash memory, erasable programmable read-only memory (EPROM), or electrically erasable programmable read-only memory (EEPROM).

Computer system 1000 may include software elements, shown as being currently located within main memory 1014, which may include an operating system, device driver(s), firmware, compilers, and/or other code, such as one or more application programs, which may include computer programs provided by various embodiments of the present disclosure. Merely by way of example, one or more steps described with respect to any methods discussed above, might be implemented as instructions 1016, executable by computer system 1000. In one example, such instructions 1016 may be received by computer system 1000 using communications subsystem 1010 (e.g., via a wireless or wired signal carrying instructions 1016), carried by communication medium 1002 to memory device(s) 1012, stored within memory device(s) 1012, read into main memory 1014, and executed by processor(s) 1004 to perform one or more steps of the described methods. In another example, instructions 1016 may be received by computer system 1000 using input device(s) 1006 (e.g., via a reader for removable media), carried by communication medium 1002 to memory device(s) 1012, stored within memory device(s) 1012, read into main memory 1014, and executed by processor(s) 1004 to perform one or more steps of the described methods.

In some embodiments of the present disclosure, instructions 1016 are stored on a computer-readable storage medium, or simply computer-readable medium. Such a computer-readable medium may be non-transitory, and may therefore be referred to as a non-transitory computer-readable medium. In some cases, the non-transitory computer-readable medium may be incorporated within computer system 1000. For example, the non-transitory computer-readable medium may be one of memory device(s) 1012, as shown in FIG. 10, with instructions 1016 being stored within memory device(s) 1012. In some cases, the non-transitory computer-readable medium may be separate from computer system 1000. In one example, the non-transitory computer-readable medium may a removable media provided to input device(s) 1006, such as those described in reference to input device(s) 1006, as shown in FIG. 10, with instructions 1016 being provided to input device(s) 1006. In another example, the non-transitory computer-readable medium may a component of a remote electronic device, such as a mobile phone, that may wirelessly transmit a data signal carrying instructions 1016 to computer system 1000 using communications subsystem 1010, as shown in FIG. 10, with instructions 1016 being provided to communications subsystem 1010.

Instructions 1016 may take any suitable form to be read and/or executed by computer system 1000. For example, instructions 1016 may be source code (written in a human-readable programming language such as Java, C, C++, C #, Python), object code, assembly language, machine code, microcode, executable code, and/or the like. In one example, instructions 1016 are provided to computer system 1000 in the form of source code, and a compiler is used to translate instructions 1016 from source code to machine code, which may then be read into main memory 1014 for execution by processor(s) 1004. As another example, instructions 1016 are provided to computer system 1000 in the form of an executable file with machine code that may immediately be read into main memory 1014 for execution by processor(s) 1004. In various examples, instructions 1016 may be provided to computer system 1000 in encrypted or unencrypted form, compressed or uncompressed form, as an installation package or an initialization for a broader software deployment, among other possibilities.

In one aspect of the present disclosure, a system (e.g., computer system 1000) is provided to perform methods in accordance with various embodiments of the present disclosure. For example, some embodiments may include a system comprising one or more processors (e.g., processor(s) 1004) that are communicatively coupled to a non-transitory computer-readable medium (e.g., memory device(s) 1012 or main memory 1014). The non-transitory computer-readable medium may have instructions (e.g., instructions 1016) stored therein that, when executed by the one or more processors, cause the one or more processors to perform the methods described in the various embodiments.

In another aspect of the present disclosure, a computer-program product that includes instructions (e.g., instructions 1016) is provided to perform methods in accordance with various embodiments of the present disclosure. The computer-program product may be tangibly embodied in a non-transitory computer-readable medium (e.g., memory device(s) 1012 or main memory 1014). The instructions may be configured to cause one or more processors (e.g., processor(s) 1004) to perform the methods described in the various embodiments.

In another aspect of the present disclosure, a non-transitory computer-readable medium (e.g., memory device(s) 1012 or main memory 1014) is provided. The non-transitory computer-readable medium may have instructions (e.g., instructions 1016) stored therein that, when executed by one or more processors (e.g., processor(s) 1004), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

The words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

Patents, patent applications, publications, and descriptions mentioned here are incorporated by reference in their entirety for all purposes. None is admitted to be prior art.

What is claimed is:

1. A system for analyzing a liquid sample comprising:
an analyzer housing defining a controlled environment;
a test cell disposed within the analyzer housing and configured to receive the liquid sample;
a laser assembly configured to generate an illumination beam and a reference beam, wherein the laser assembly is arranged to direct the illumination beam toward the test cell;
a signal detector arranged to receive a signal beam from the test cell and generate signal data based on receiving the signal beam from the test cell;
a reference detector arranged to receive the reference beam and generate reference data based on the reference beam; and
a control system operatively coupled with the laser assembly and the reference detector, the control system configured to:
vary a wavelength of the illumination beam and the reference beam within a time period;
analyze the reference data generated during the time period to perform a self-check that evaluates a presence of unwanted vapor within the analyzer housing; and
ascertain a status of the controlled environment for performing spectral analysis of the liquid sample based on the self-check evaluating the presence of unwanted vapor.

2. The system of claim 1, wherein the control system is configured to perform one or more of the following actions in response to ascertaining the status of the controlled environment:
control a purge assembly to direct a purge fluid into the analyzer housing responsive to evaluation of the presence of unwanted vapor;
initiate spectral analysis of the liquid sample only when the status of the controlled environment indicates the presence of unwanted vapor is below a predetermined threshold; and/or
transmit an electronic notification to a user interface indicating that a fluid analyzer is ready or not ready for spectral analysis of the liquid sample based on the status of the controlled environment.

3. The system of claim 1, further comprising a purge assembly that selectively directs a purge fluid into the analyzer housing in response to ascertaining the status of the controlled environment.

4. The system of claim 1, wherein the laser assembly comprises a tunable mid-infrared (MIR) laser configured to vary the wavelength across a spectral range between approximately 2 and 20 microns.

5. The system of claim 1, wherein the control system is configured to perform the self-check by identifying sharp absorption peaks in the reference data.

6. The system of claim 5, wherein the control system is configured to utilize a convex hull algorithm on the reference data to identify the sharp absorption peaks.

7. The system of claim 6, wherein the control system is configured to quantify an amount of unwanted vapor based on an amplitude of the sharp absorption peaks.

8. The system of claim 1, wherein the control system is configured to perform a second self-check by calculating a standard deviation of a flattened rolling ratio of the reference data collected over a predetermined test time to evaluate a stability of the system.

9. The system of claim 1, further comprising a beam splitter configured to split between one percent and fifty percent of the illumination beam from the laser assembly to create the reference beam.

10. The system of claim 1, wherein the control system analyzes the signal data and the reference data to spectrally analyze the liquid sample during the time period.

11. The system of claim 1, wherein:
the time period is a first time period;
the reference data is first reference data;
the self-check is a first self-check;
during a second time period later in time than the first time period, the laser assembly is configured to vary the wavelength of the illumination beam;
the reference detector is configured to generate second reference data during the second time period;
the control system is configured to analyze the second reference data to perform a second self-check to evaluate the presence of unwanted vapor within the analyzer housing during the second time period; and
the second self-check is a different type of self-check than the first self-check.

12. The system of claim 11, wherein:
the second time period is longer than the first time period;
the first self-check is a rapid check that comprises identifying sharp absorption peaks in the first reference data; and
the second self-check is a stability check that comprises analyzing rolling ratios and/or standard deviations of reference data.

13. A method for analyzing a chamber for unwanted vapor comprising:
receiving a liquid sample in a test cell disposed within an analyzer housing, the analyzer housing defining a controlled environment;
generating an illumination beam and a reference beam with a laser assembly;
directing the illumination beam toward the test cell;
receiving, at a signal detector, a signal beam from the test cell and generating signal data based on receiving the signal beam;
receiving, at a reference detector, the reference beam and generating reference data based on the reference beam;
varying a wavelength of the illumination beam and the reference beam within a time period;
analyzing the reference data generated during the time period to perform a self-check that evaluates a presence of unwanted vapor within the analyzer housing; and
ascertaining a status of the controlled environment for performing spectral analysis of the liquid sample based on the self-check evaluating the presence of unwanted vapor.

14. The method of claim 13, further comprising performing one or more of the following actions in response to ascertaining the status of the controlled environment:
controlling a purge assembly to direct a purge fluid into the analyzer housing responsive to evaluation of the presence of unwanted vapor;
initiating spectral analysis of the liquid sample only when the status of the controlled environment indicates the presence of unwanted vapor is below a predetermined threshold; and/or
transmitting an electronic notification to a user interface indicating that a fluid analyzer is ready or not ready for spectral analysis of the liquid sample based on the status of the controlled environment.

15. The method of claim 13, wherein varying the wavelength of the illumination beam comprises sweeping a mid-infrared (MIR) laser across a spectral range between approximately 2 and 20 microns.

16. The method of claim 13, wherein performing the self-check comprises identifying sharp absorption peaks in the reference data.

17. The method of claim 13, wherein performing the self-check comprises performing a stability check including calculating a standard deviation of a flattened rolling ratio of reference data collected over a predetermined test time.

18. The method of claim 13, wherein:
the time period is a first time period, the reference data is first reference data, and the self-check is a first self-check;
the method further comprises performing a second self-check during a second time period later in time than the first time period; and
the second self-check is a different type of self-check than the first self-check.

19. A non-transitory computer-readable medium storing instructions that, when executed by one or more processors of a control system for a fluid analyzer, cause the one or more processors to perform operations comprising:
receiving signal data from a signal detector and reference data from a reference detector;
instructing a laser assembly to vary a wavelength of an illumination beam and a reference beam within a time period;
analyzing the reference data generated during the time period to perform a self-check that evaluates a presence of unwanted vapor within an analyzer housing of the fluid analyzer; and
ascertaining a status of a controlled environment within the analyzer housing for performing spectral analysis of a liquid sample based on the self-check evaluating the presence of unwanted vapor.

20. The non-transitory computer-readable medium of claim 19, wherein the operations further comprise performing one or more of the following actions in response to ascertaining the status of the controlled environment:
controlling a purge assembly to direct a purge fluid into the analyzer housing responsive to evaluation of the presence of unwanted vapor;
initiating spectral analysis of the liquid sample only when the status of the controlled environment indicates the presence of unwanted vapor is below a predetermined threshold; and/or
transmitting an electronic notification to a user interface indicating a readiness of the fluid analyzer for spectral analysis of the liquid sample based on the status of the controlled environment.
